(19) United States
(12) Patent Application Publication
(10) Pub. No.: US 2018/0225605 A1
(43) Pub. Date: Aug. 9, 2018

(54) RISK ASSESSMENT AND ALERT SYSTEM

(71) Applicant: American Express Travel Related Services Company, Inc., New York, NY (US)

(72) Inventors: Paul Fabara, New York, NY (US); Anna Bertoni, New York, NY (US); Suraj Madnani, New York, NY (US); John Ryan, Lake Worth, FL (US); Ravi Varma, New York, NY (US)

(73) Assignee: American Express Travel Related Services Company, Inc., New York, NY (US)

(21) Appl. No.: 15/481,333

(22) Filed: Apr. 6, 2017

Related U.S. Application Data
(60) Provisional application No. 62/455,390, filed on Feb. 6, 2017.

(51) Int. Cl. G06Q 10/06; G06F 17/14

(52) U.S. Cl. CPC G06Q 10/0635; G06F 17/14

(57) ABSTRACT

A system for monitoring risk and generating alerts may include an interface to generate KRIs and KPIs. A monitoring station may use the KRIs and KPIs to evaluate data streams for risk. In response to detecting risks based on the KRIs and/or KPIs, the monitoring station may generate an alert. The alert may be assigned to a user account, for example, for the associated user to evaluate and work through resolution activities associated with the alert.

### CLAIM TO PRIORITY

This application claims priority to U.S. Provisional Patent Application No. 62/455,390, which was filed on Feb. 6, 2017 and entitled “RISK ASSESSMENT AND ALERT SYSTEM” and is incorporated by reference herein in its entirety.

### FIELD

This disclosure relates to systems and methods for analyzing and responding to risks embedded in processes, transactions, and interactions.

### BACKGROUND

Most businesses face risk in some form or another. Large organizations face various types of risks such as, for example, crisis management, product management, input technology, input security, operational risk, market risk, credit risk, compliance risk, internal fraud risk, disaster recovery, business continuity risk, legal risk, and so on. Risk officers are often trained to assess specific types of risk, but are usually not experts in all risk types. Instead, these specialized individuals typically operate in a compartmentalized manner and are often not informed as to the other compartmentalized risk assessments. In that regard, the expertise of various experts is usually not brought together to make a big-picture assessment for considering various risk types in a coordinated manner. In other words, without a sufficient big picture view, risk officers may have a harder time evaluating risk trade-offs,

The growing number and size of data sources augments the inefficiencies of the compartmentalized approach. For example, big data has resulted in systems with billions of rows and hundreds of thousands of columns worth of data in a single table. These expansive data sets are often subject to duplicative review by the various compartmentalized risk officers. The number and scope of risk sources also usually have the undesirable side effect of generating a substantial number of risks. The resources and frequency associated with the risks combined with the constraints in the above areas often results in only a small number of the risks being monitored at a given point in time.

### SUMMARY

A system, method, and computer readable medium (collectively, the “system”) is disclosed for assessing risk and generating alerts. A system for monitoring risk and generating alerts may include an interface to build KRIs and KPIs. A monitoring station may use the KRIs and KPIs to evaluate data streams for risk. In response to detecting risks based on the KRIs and/or KPIs, the monitoring station may generate an alert. The alert may be assigned to a user account, for example, for the associated user to evaluate and work through resolution activities associated with the alert.

The forgoing features and elements may he combined in various combinations without exclusivity, unless expressly indicated herein otherwise. These features and elements as well as the operation of the disclosed embodiments will become more apparent in light of the following description and accompanying drawings.

### BRIEF DESCRIPTION

The subject matter of the present disclosure is particularly pointed out and distinctly claimed in the concluding portion of the specification. A more complete understanding of the present disclosure, however, may be obtained by referring to the detailed description and claims when considered in connection with the drawing figures, wherein like numerals denote like elements.

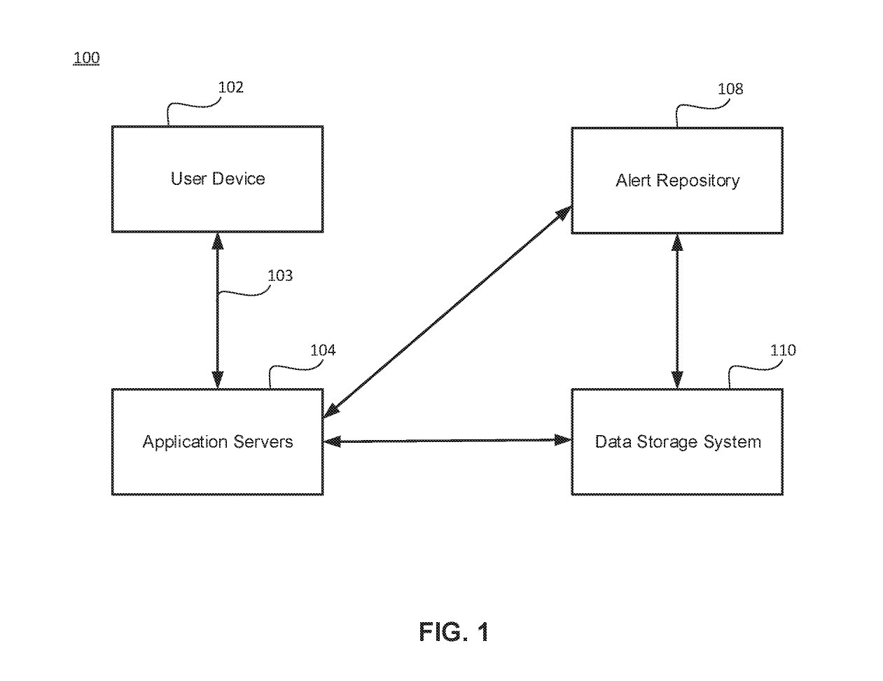

FIG. 1 illustrates an exemplary system for risk analysis and alert generation, in accordance with various embodiments;

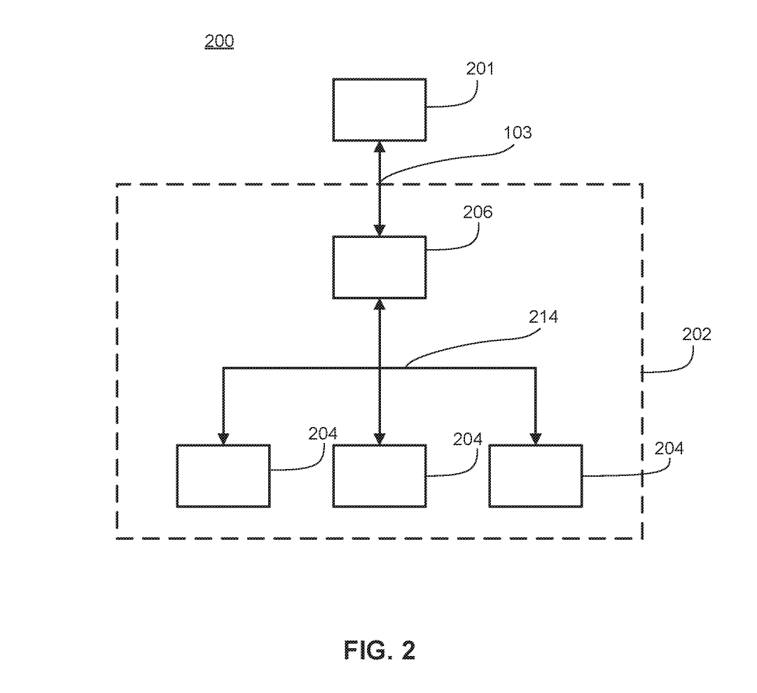

FIG. 2 illustrates an exemplary system for storing, reading, and writing big data sets, in accordance with various embodiments;

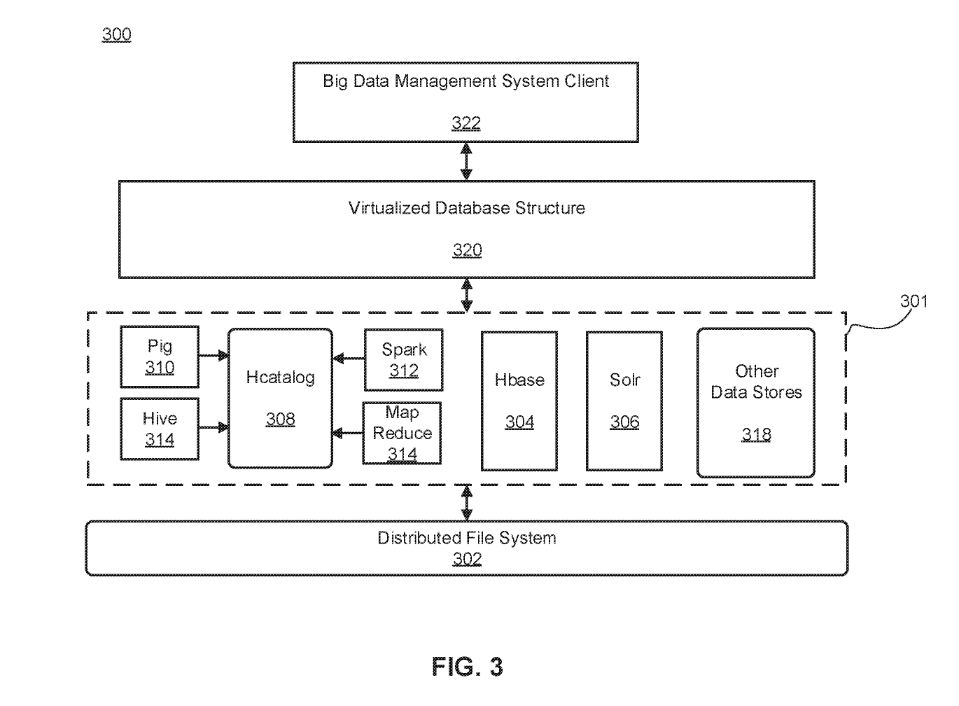

FIG. 3 illustrates an exemplary big data management system supporting a unified, virtualized interface for multiple data storage types, in accordance with various embodiments;

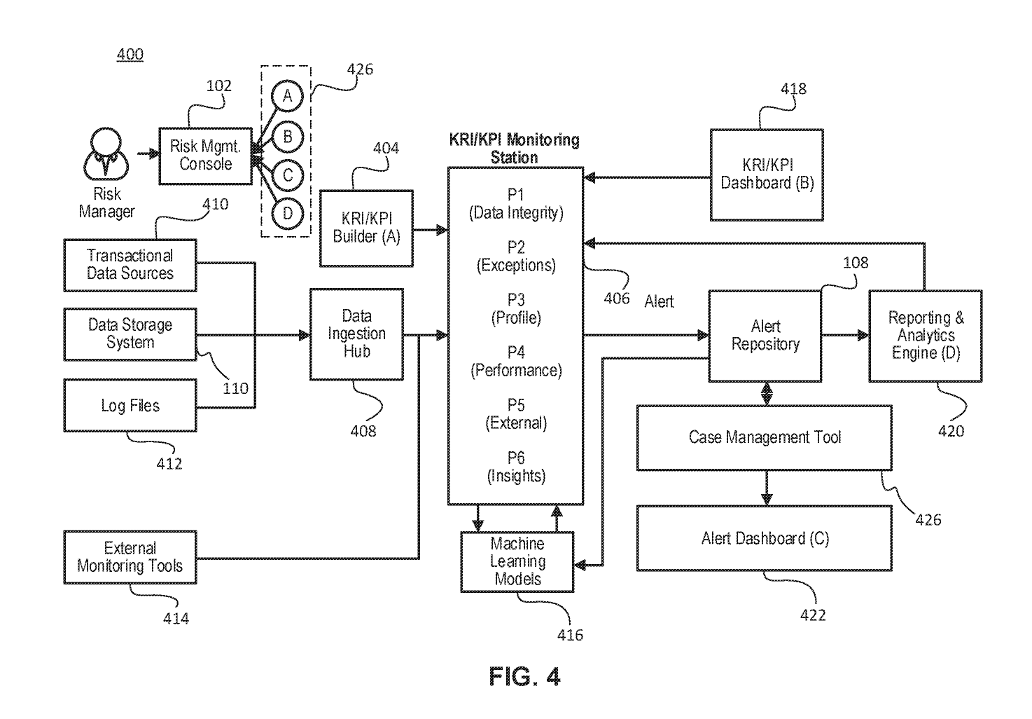

FIG. 4 illustrates an exemplary system for risk analysis and alert generation, in accordance with various embodiments;

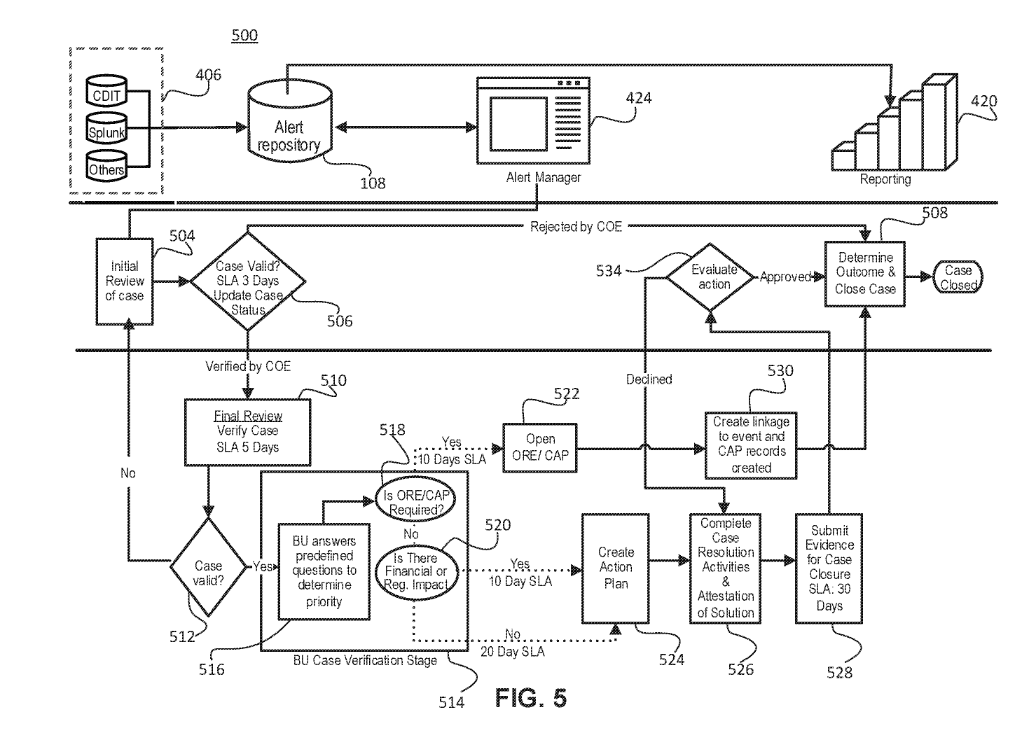

FIG. 5 illustrates an exemplary process for generating and responding to alerts, in accordance with various embodiments;

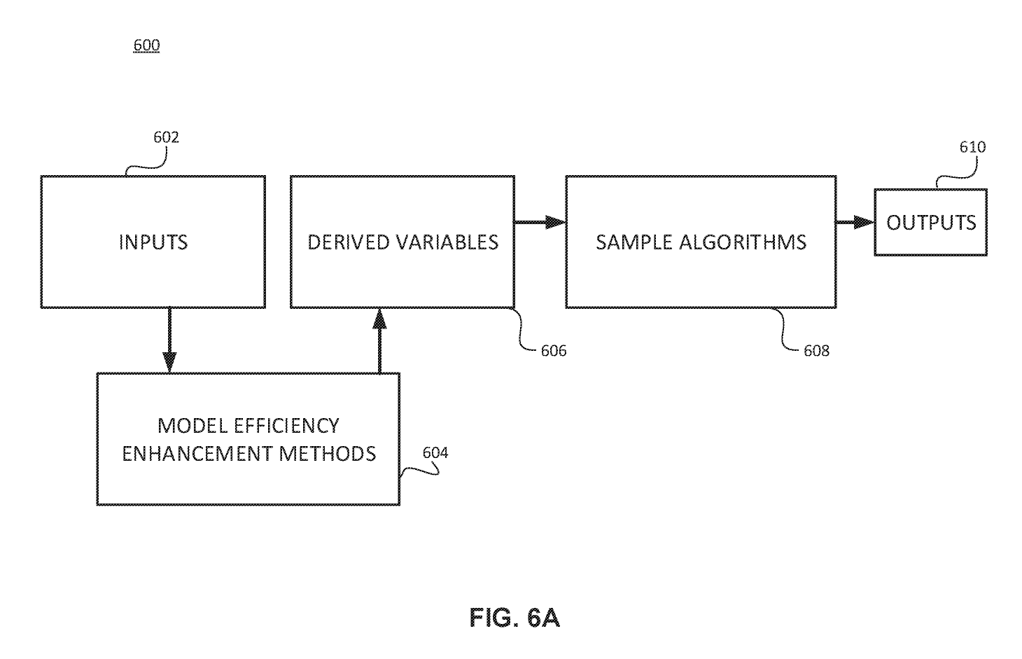

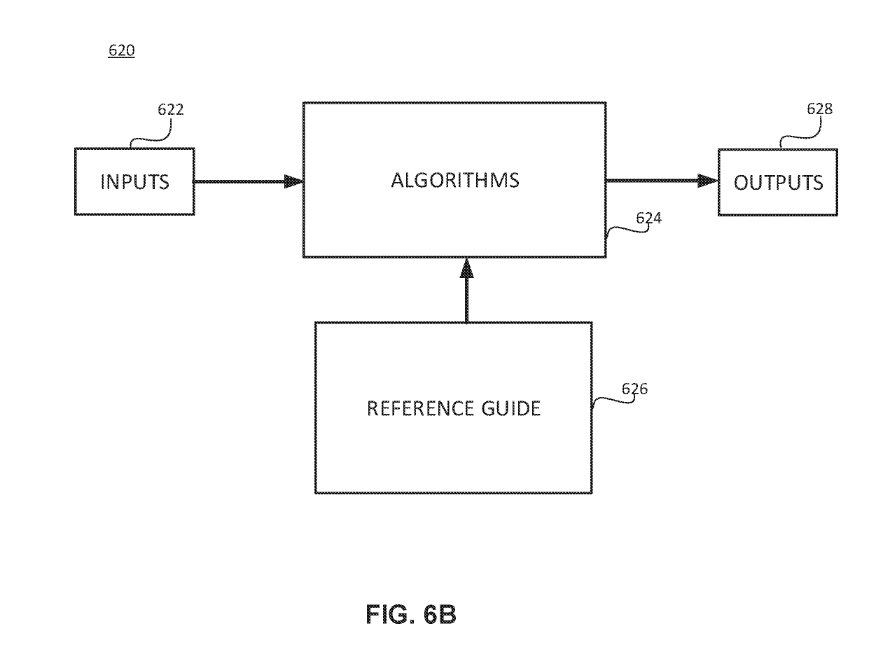

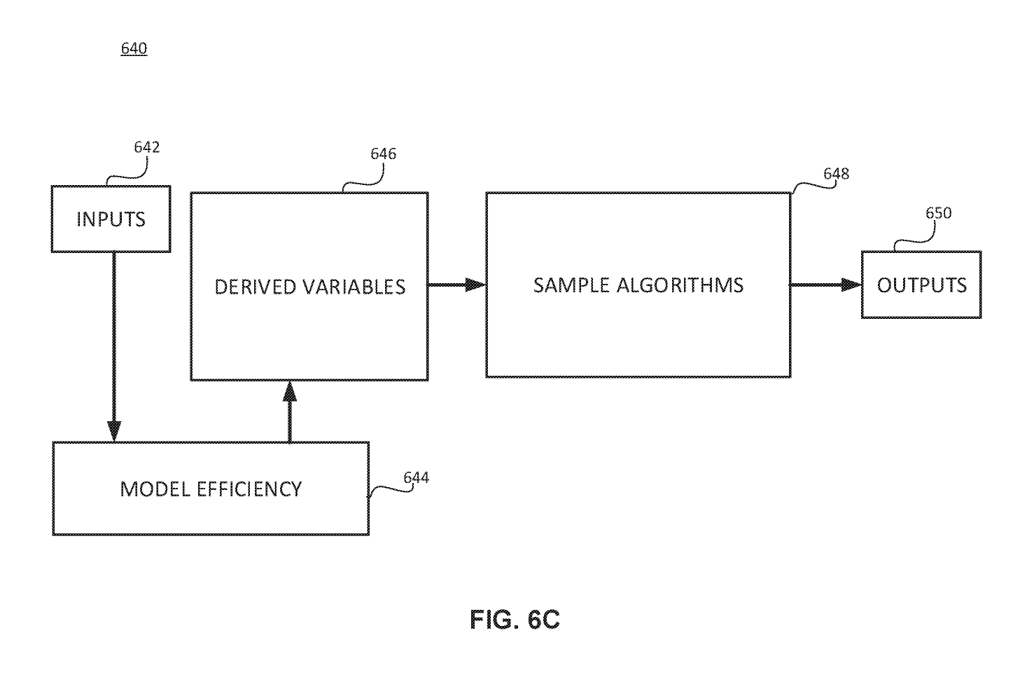

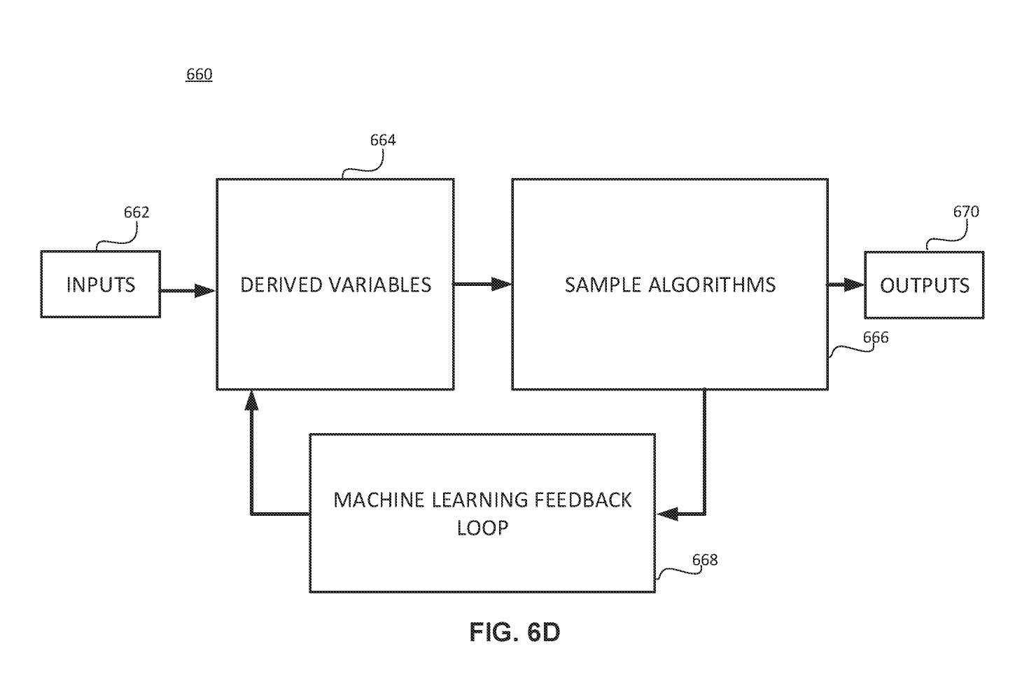

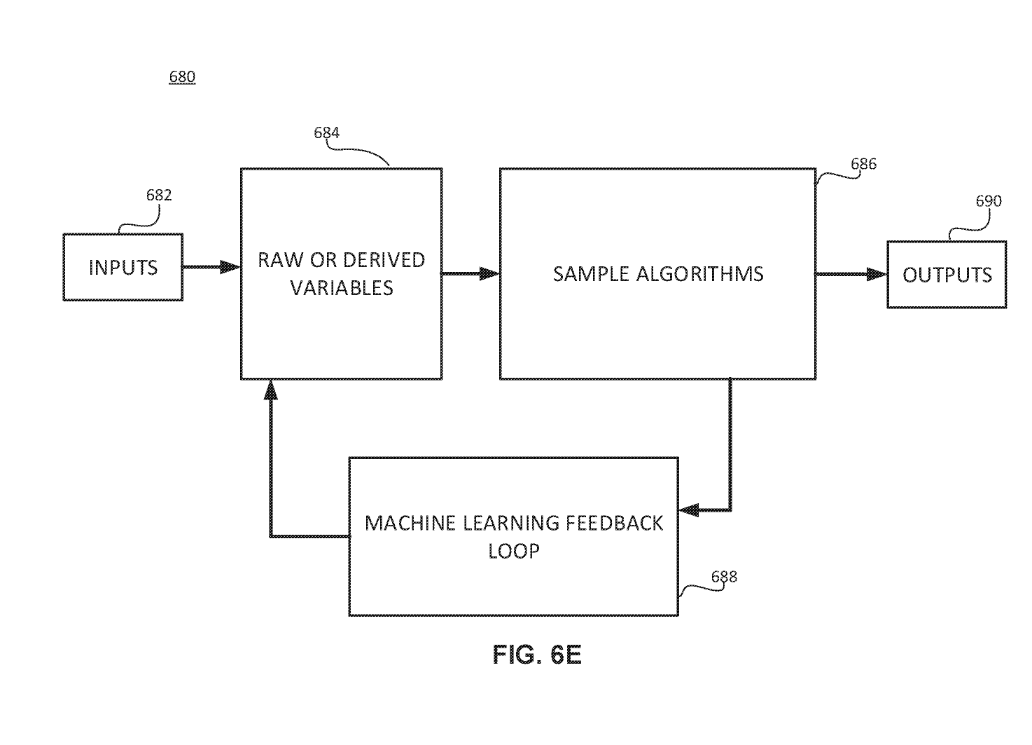

FIG. 6A illustrates an exemplary process for applying data integrity KRIs to input data to detect risks, in accordance with various embodiments;

FIG. 6B illustrates an exemplary process for applying exception KRIs to input data to detect risks, in accordance with various embodiments;

FIG. 6C illustrates an exemplary process for applying profile KRIs and performance KPIs to input data to detect risks or performance variations, in accordance with various embodiments;

FIG. 6D illustrates an exemplary process for applying Kills to external input data to identify risks, in accordance with various embodiments; and

FIG. 6E illustrates an exemplary process for generating insights based on KRIs, KPIs, and/or alerts, in accordance with various embodiments.

### DETAILED DESCRIPTION

The detailed description of various embodiments herein refers to the accompanying drawings and pictures, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

As used herein, “big data” may refer to partially or fully structured, semi-structured, or unstructured data sets including hundreds of thousands of columns and records. A big data set may be compiled, for example, from a history of purchase transactions over time, from web registrations, from social media, from records of charge (ROC), from summaries of charges (SOC), from internal data, and/or from other suitable sources. Big data sets may be compiled with or without descriptive metadata such as column types, counts, percentiles, and/or other interpretive-aid data points. The big data sets may be stored in various big-data storage formats containing millions of records (i.e., rows) and numerous variables (i.e., columns) for each record.

Referring now to FIG. 1, a risk analysis system 100 for monitoring data streams from various data storage systems is shown, in accordance with various embodiments. Risk analysis system 100 may include various computing devices in communication with a data storage system 110 over a network 103. The various devices may include user device 102, application servers 104, and alert repository 108. The user device 102, application servers 104, alert repository 108, and data storage system 110 may include a computer or processor, or a set of computers/processors, such as a personal computer. However, other types of computing units or systems may be used including laptops, notebooks, hand held computers, personal digital assistants, cellular phones, smart phones (e.g., iPhone®, BlackBerry®, Android®, etc.) tablets, wearables, Internet of Things (IoT) devices, or any other device capable of sending and/or receiving data over the network 103.

A network may be any suitable electronic link capable of carrying communication between two or more computing devices. For example, network 103 may be local area network using TCP/IP communication or wide area network using communication over the Internet. Network 103 may also be an internal network isolated from the Internet. User device 102, application servers 104, alert repository 108, and or data storage system 110 may be in electronic communication via network 103. A network may be (insecure. Thus, communication over the network may utilize data encryption. Encryption may be performed by way of any of the techniques now available in the art or which may become available (e.g., Twofish, RSA, El Gamal, Schorr signature, DSA, PGP, PKI, GPG, or other symmetric and asymmetric cryptography systems).

In various embodiments, data storage system 110 may be also be a computing device or system of computing devices similar to or the same as those described above configured to support data writing and/or retrieval. For example, data storage system 110 may be a big data system as described herein with reference to FIGS. 2 and 3. Data storage system 110 may also comprise data streams reviewable by comparison to predetermined rules. Data storage system 110 may respond to file requests (e.g., read and write) received from application servers 104 or alert repository 108, for example. A process may evaluate data ingested into, stored in, or otherwise available at data storage system 110 for compliance with rules. In response to data matching a rule, an alert may be generated and stored in alert repository 108. Application servers 104 may provide web services in the form of a web site or dashboard accessible by a user device 102 to review and/or act on alerts in alert repository 108 and data in data storage system 110.

With reference to FIG. 2, data storage system 110 may be a distributed file system (DFS) 200, in accordance with various embodiments. DFS 200 may comprise a distributed computing cluster 202 configured for parallel processing and storage. Distributed computing cluster 202 may comprise a plurality of nodes 204 in electronic communication with each of the other nodes, as well as a control node 206. Processing tasks may be split among the nodes of distributed computing cluster 202 to improve throughput and enhance storage capacity. Distributed computing cluster may be, for example, a Hadoop® cluster configured to process and store big data sets with some of nodes 204 comprising a distributed storage system and sonic of nodes 204 comprising a distributed processing system. In that regard, distributed computing cluster 202 may be configured to support a Hadoop® distributed file system (HDFS) as specified by the Apache Software Foundation at http://hadoop.apache.org/docs/.

In various embodiments, nodes 204, control node 206, and user device 102 may comprise any devices capable of receiving and/or processing at least a portion of an electronic message via network 103 and/or network 214. For example, nodes 204 may take the form of a computer or processor, or a set of computers/processors, such as a system of rack-mounted servers. However, other types of computing units or systems may be used, including laptops, notebooks, hand held computers, personal digital assistants, cellular phones, smart phones (e.g., iPhone®, BlackBerry®, Android®, etc.) tablets, wearables (e.g., smart watches and smart glasses), or any other device capable of receiving data over the network.

In various embodiments, a computing device 201 may submit requests to control node 206. Computing device 201 may comprise a user device 102, application server 104, or any other computing device capable of communication with control node 206 over a network. Control node 206 may distribute the tasks among one or more of nodes 204 for processing to partially or fully complete the job intelligently. Control node 206 may limit network traffic and/or enhance the speed at which incoming data is processed. In that regard, computing device 201 may be a separate machine from distributed computing cluster 202 in electronic communication with distributed computing cluster 202 via network 103. Nodes 204 and control node 206 may similarly be in communication with one another over network 21.4. Network 214 may be an internal network isolated from the Internet and computing device 201, or, network 214 may comprise an external connection to enable direct electronic communication with computing device 201 and the Internet.

In various embodiments, DFS 200 may partially or fully process hundreds of thousands of records from a single data source. DFS 200 may also partially or fully ingest data from hundreds of data sources. Nodes 204 may process some or all of the data in parallel to expedite the processing. Furthermore, the transformation and/or intake of data as disclosed herein may be carried out in memory on nodes 204. For example, in response to receiving a source data file of 100,000 records, a system with 100 nodes 204 may distribute the task of processing 1,000 records to each node 204. Each node 204 may then process the stream of 1,000 records while maintaining the resultant data in memory until the batch is complete for batch processing jobs. The results may be written, augmented, logged, and/or written to disk for subsequent retrieval. The results may be written to disks using various big data storage formats.

With reference to FIG. 3, an exemplary architecture of a big data management system (BDMS) 300 is shown, in accordance with various embodiments. BDMS 300 may be similar to or identical to DFS 200 of FIG. 2, for example, DFS 302 may serve as the physical storage medium for the various data storage formats 301 of DFS 302. A non-relational database 304 may be maintained on DFS 302. For example, non-relational database 304 may comprise an HBase™ storage format that provides random, real time read and/or write access to data, as described and made available by the Apache Software Foundation at http://hbase.apache.org/.

In various embodiments, a search platform 306 may be maintained on DFS 302. Search platform 306 may provide distributed indexing and load balancing to support fast and reliable search results. For example, search platform 306 may comprise a Solr® search platform as described and made available by the Apache Software Foundation at http://lucene.apache.org/solr/.

In various embodiments, a data warehouse 314 such as Hive® may be maintained on DFS 302. The data warehouse 314 may support data summarization, query, and analysis of warehoused data. For example, data warehouse 314 may be a Hive® data warehouse built on Hadoop® infrastructure. A data analysis framework 310 may also be built on DFS 302 to provide data analysis tools on the distributed system. Data analysis framework 310 may include an analysis runtime environment and an interface syntax such similar to those offered in the Pig platform as described and made available by the Apache Software Foundation at https://pig.apache.org/.

In various embodiments, a cluster computing engine 312 for high-speed, large-scale data processing may also be built on DFS 302. For example, cluster computing engine 312 may comprise an Apache Spark™ computing framework running on DFS 302. DFS 302 may further support a MapReduce layer 316 for processing big data sets in a parallel, distributed manner to produce records for data storage formats 301. For example, MapReduce layer 316 may be a Hadoop® MapReduce framework distributed with the Hadoop® HDFS as specified by the Apache Software Foundation at http://hadoop.apache.org/docs/. The cluster computing engine 312 and MapReduce layer 316 may ingest data for processing, transformation, and storage in data storage formats 301 using the distributed processing and storage capabilities of DFS 302.

In various embodiments, DFS 302 may also support a table and storage management layer 308 such as, for example, an HCatalog installation. Table and storage management layer 308 may provide an interface for reading and writing data for multiple related storage formats. Continuing the above example, an HCatalog installation may provide an interface for one or more of the interrelated technologies described above such as, for example, Hive®, Pig, Spark®, and Hadoop® MapReduce.

In various embodiments, DFS 302 may also include various other data storage formats 318. Other data storage formats 318 may have various interface languages with varying syntax to read and/or write data. In fact, each of the above disclosed storage formats may vary in query syntax and interface techniques. Virtualized database structure 320 may provide a uniform, integrated user experience by offering users a single interface point for the various different data storage formats 301 maintained on DFS 302. Virtualized database structure 320 may be a software and/or hardware layer that makes the underlying data storage formats 301 transparent to client 322 by providing variables on request. Client 322 may request and access data by requesting variables from virtualized database structure 320. Virtualized database structure 320 may then access the variables using the various interfaces of the various data storage formats 301 and return the variables to client 322.

In various embodiments, the data stored using various of the disclosed data storage formats 301 may be stored across data storage formats 301 and/or accessed at a single point through virtualized database structure 320. The variables accessible through virtualized database structure 320 may be similar to a column in a table of a traditional RDBMS. That is, the variables identify data fields available in the various data storage formats 301,

In various embodiments, variables may be stored in a single one of the data storage formats 301 or replicated across numerous data storage formats 301 to support different access characteristics. Virtualized database structure 320 may comprise a catalog of the various variables available in the various data storage formats 301. The cataloged variables enable BDMS 300 to identify and locate variables stored across different data storage formats 301 on DFS 302. Variables may be stored in at least one storage format on DFS 302 and may be replicated to multiple storage formats on DFS 302. The catalog of virtualized database structure 320 may track the location of a variable available in multiple storage formats.

The variables may be cataloged as they are ingested and stored using data storage formats 301. The catalog may track the location of variables by identifying the storage format, the table, and/or the variable name for each variable available through virtualized database structure 320. The catalog may also include metadata describing what the variables are and where the variables came from such as, for example, data type, original source variables, timestamp, access restrictions, sensitivity of the data, and/or other descriptive metadata. For example, internal data and/or PII may be flagged as sensitive data subject to access restrictions by metadata corresponding to the variable containing the internal data and/or PII. Metadata may be copied from the storage formats 301 or generated separately for virtualized database structure 320.

In various embodiments, virtualized database structure 320 may provide a single, unified, and virtualized data storage format that catalogues accessible variables and provides a single access point for records stored on data storage formats 301. Client 322 (which may operate using similar hardware and software to client 210 of FIG. 1) may access data stored in various data storage formats 301 via the virtualized database structure 320. In that regard, virtualized database structure 320 may be a single access point for data stored across the various data storage formats 301 on DFS 302.

In various embodiments, virtualized database structure 320 may store and/or maintain the catalog of variables including locations and/or descriptive metadata, but virtualized database structure 320 may not store the actual data contained in each variable. The data that fills the variables may be stored on DFS 302 using data storage formats 301. Virtualized database structure 320 may enable read and/or write access to the data stored in data storage formats 301 without a client system having knowledge (or minimal knowledge) of the underlying data storage formats 301.

With reference to FIG. 4, a system 400 for assessing risk and generating alerts is shown, in accordance with various embodiments. System 400 may include a risk manager interfacing with a user device 102 (e.g., a risk management console). User device 102 may run a case management tool 426 to present various interfaces and information to risk manager and enable appropriate actions. For example, user device 102 may interface with the various components of system 400 to render a known-risk-indicator (KRI)/known-performance-indicator (KPI) builder 404, a KRI/KPI dashboard 418, a reporting and analytics engine 420, and/or an alert dashboard 422 for interaction with a risk manager.

In various embodiments, builder 404 may allow an individual operating as a risk manager to code and recalibrate KRIs on the fly. For example, it may allow a risk manager to track the response to a marketing campaign (e.g., a social media campaign) in real-time or respond to an event in real-time. Dashboard 422 may provide a real-time view of the monitored risk via charts, graphs, tables, and/or numeric values. Reporting and analytics engine 420 may have reporting capability to perform analytics and generate reports. The output from the reporting engine may be used for control and compliance ratings of business units, recommending reviews for the risk management organization, external tests performed by auditors and regulators, or other suitable reports.

In various embodiments, KRI/KPI builder 404 may include a tool for creating, calibrating, recalibrating, editing, or otherwise generating KRIs and/or KPIs. A risk manager may generate a new KRI or KPI using builder 404 running on user device 102 as a native application and/or web application, for example, to enter and/or identify relevant risk information. In that regard, a KRI or KPI may take the form of a segment of code with a formula, algorithm, and/or a model applicable to a data stream to detect a risk. The monitoring station may run the code based on a preset schedule (e.g., real-time to daily to monthly). In that regard, risk manager may alter behavior of system 400 by identifying new risks, modifying existing risk thresholds, and/or otherwise generating risk-analysis rules for use in monitoring station 406.

Monitoring station 406 may partially or fully evaluate, monitor, and/or generate KRIs and KPIs categorizable as relating to data integrity, exceptions, profiles, performance, external and/or other KRI and KPI categories using processes detailed in FIGS. 6A to 6E and described in detail below. Monitoring station 406 may also generate insights in response to the monitored KRIs and KPIs. Data integrity risk may include the risk associated with the integrity of data and variables used in models and decision rules. Exception risk may include monitoring adherence to regulations, compliance issues, and/or internal policies. Profile risks may include risks associated with out of pattern changes or activity associated across the entire profile of the underlying entity. The underlying entity is context specific and depends on the process in which risks are being monitored. For example, the underlying entity in a complaints process may be complaints, while the underlying entity in the acquisition process may be applicants, and the underlying entity in the fraud process are fraud events. Performance risk may include out-of-pattern changes in performance.

External risks may stem from the environment outside of a primary entity (e.g., from a third party) but still affect the primary entity. Examples include social media (Reputational Risk), a new product launch (Competitive Risk), or macro-economic changes (Macro-economic Risk). Insights may he derived from any monitored risk to present actionable data to risk analysts.

For example, in response to a user applying for a new credit account, the KRIs and KPIs categorized as described above may each be applied in real-time at monitoring station 406. Data integrity may be evaluated by analyzing the data in variables used in making the credit decision to identify anomalies and determine whether the data tracks previously determined rules using the code included in the applicable KRIs and/or KPIs. Exceptions may be analyzed by determining whether the applicant is appropriate for auto approval without an internal risk score check based on the credit score being suitably high, whether the applicant has applied elsewhere within a predetermined time period, and/or whether any cards have been mailed to non-US addresses or PO boxes, for example, using the code included in the applicable KRIs and/or KPIs.

Continuing the above example, profiles may be analyzed by considering average credit score, average risk scores, and/or percentage of revolving accounts over predetermined periods using the code included in the applicable KRIs and/or KPIs to evaluate a data stream. Performance may be analyzed based on KPIs such as, for example, delinquency rates over predetermined time periods in identified account-holder segments, decline rate in identified account-holder segments, and/or profitability in identified card-holder segments using the code included in the KPI to evaluate a data stream. Externalities may be assessed by evaluating the external sentiment surrounding a new product launch or product refresh using the code included in the applicable KRIs and/or KPIs. The various risk analysis categories identified above are disclosed for exemplary purposes and are not intended to be limiting.

In various embodiments, monitoring station 406 may apply rules and/or KRIs to data streams and/or data sources to various evaluate risks. Transactional data sources 410, data storage system 110, log tiles 412, or other data streams may be input into data ingestion hub 408. The data ingestion hub may operate my mapping incoming data into variables. In that regard, data ingestion hub 408 may ingest structured, semi-structured and/or unstructured data from a diverse set of data sources including systems of record (SORs), data storage system 110, external sources (e.g., OECD, websites, blogs, S&P etc.), and/or other data sources from across an enterprise. The data ingestion hub may improve the overall quality of data flowing through it by, for example, data wrangling or correlating with data keys across data sources. The rules and KRIs may be applied to the data in these variables to identify and evaluate risks by monitoring station 406, which operates on the ingested data.

In various embodiments, external monitoring tools 414 may also be fed into monitoring station 406 as an additional data point for risk evaluation. External monitoring tools may include processes and systems that generate outputs similar to monitoring station 406. Groups within an entity may provide external monitoring tools that monitor processes, even if they may not be from a risk standpoint. For example, an IT group may be constantly monitoring server logs for any server related issues. A risk assessment team may manually build KRIs in the IT-group monitoring tool and receive the output from the KRIs directly. External monitoring tools may include a third party monitoring station generating outputs similar to monitoring station 406.

Monitoring station 406 may also improve rule sets for monitoring risk, analyzing risk, and raising alerts responsive to risk using machine-learning algorithms. Exemplary machine learning algorithms include gradient boosted machines, logistic regression, linear regression, decision trees, support vector machines, nearest neighbors, or other suitable machine learning algorithms. In order to facilitate machine-learning, outcomes from previous decisions may be input into monitoring station 406 as feedback from reporting and analytics engine 420 and/or alert repository 108, for example

In various embodiments, alert repository 108 may store alerts generated by monitoring station 406 and/or case management tool 426. Reporting & analytics engine 420 and/or alert dashboard 406 may read data from alert repository 108. Alert dashboard 422 may include an interface to display alerts on user device 102. Alert dashboard 422 may retrieve alerts for display from case management tool 426 and/or alert repository 108 based on the user logged into user device 102. In that regard, each risk manager may access alerts assigned to her through the alert dashboard.

In various embodiments, system 400 supports the partial or full creation, execution and/or monitoring of KRIs and KPIs through data science, technology and predictive machine-learning models to proactively and reactively monitor risk across various business units, functions, products, processes, policies, regulations, and risk types. Examples of various risk monitoring applications in a financial institution may include compliance KRIs, existing alerts, new accounts, loans, social media, exposure aggregation, lines of credit, marketing offer fulfillment, complaints, information technology KRIs. The system creates alerts when models detect anomalies in the underlying risk. The system may also assign alerts to concerned stakeholders.

With reference to FIG. 5, an exemplary flow chart is shown depicting process 500 for generating alerts and/or managing the alert through an evaluation period, in accordance with various embodiments. Monitoring station 406 may be interact with alert repository 108. Alert repository 108 may be the centralized location for alert storage as described above. Case management tool 426 may be used to evaluate alerts and process alerts stored in alert repository 108 in real-time. Reporting and analytics engine 420 may generate reports and analysis relating to alerts based on the alerts in alert repository 108. 100511 In response to an alert being generated (e.g., by monitoring station 406), the alert may be initially reviewed (Block 504). The initial review may assess whether the alert is a false positive or merits further investigation and/or action (Block 506). The alert may be rejected in response to the alert relating to a false positive, an insignificant issue, or a misclassified risk, for example. The determination whether the alert is actionable may be completed within a predetermined period from generation of the alert (e.g., three days). The outcome may be determined and entered and the case may be closed (Block 508) in response to the determination that the case is not valid. In response to cases being closed, the outcomes may be used as feedback to monitoring station 406 for input into machine learning algorithms.

In response to the alert being verified as an actionable and/or accurately generated alert, the alert may be passed to the first line responders of a business unit to verify the alert (Block 510). The verification may be conducted within a predetermined time period from the initial decision of block 506. The business unit may determine whether the alert is valid (Block 512). In response to the alert being invalid, the case may be returned from the business unit to the initial review step. The initial review may take into consideration additional data from the business unit input into the case using case management tool 426. 100531 In various embodiments, the case may be passed to the business unit case verification stage 514 in response to determining the alert is valid. The business unit may answer identified questions associated with the alert to determine priority (Block 516). The questions may be used to determine whether an operation risk event (ORE) or collective action plan (CAP) should be opened (Block 518). ORE is opened in response to an event where there is an operational risk serious enough to warrant a larger investigation. Typically, it is associated with operational losses. CAPs are a more severe version of an ORE where there is customer harm along with a financial loss. These could be created where a regulation is in conflict. Policies for an entity may define the ORE and CAP process that includes when the ORE and CAP need to be opened.

In response to ORE/CAP being required, an ORE/CAP may be opened (Block 522). The ORE/CAP may be opened and/or processed on an accelerated timeline such as, for example, ten days. A linkage may be created from the case to the event and CAP records may be created (530).

In various embodiments, in response to ORE/CAP not being required, the questions can be used to determine whether there is a financial or regulatory impact associated with the alert (Block 520). An action plan may be generated (Block 524). The action plan may be generated with an accelerated timeline in response to the alert having a regulatory or financial impact. The action plan may be generated with a longer or standard timeline in response to the alert having no financial or regulatory impact.

In various embodiments, the business unit may complete case resolution activities and attestation of the solution (Block 526). Case resolution activities may be determined based on the alert and answers to questions. In response to completion of case resolution activities, the business unit may submit evidence for case closure (Block 528). The evidence may be returned to the compliance department for evaluation. The first line action may be evaluated and approved or declined based on the sufficiency of the solution, evidence, or other available data (Block 534). In response to the first line action being declined, the case may be returned to the business unit to complete additional case resolution activities and attestation of solution. In response to the first time action being approved, the outcome may be determined and the case may be closed.

FIGS. 6A through 6E depict the flow charts for use by monitoring station 406 in evaluating data streams using various KRIs and/or KPIs. Referring now to FIG. 6A, process flow 600 depicts the process of evaluating data integrity using KRIs, in accordance with various embodiments. Inputs 602 may be collected from a data source, such as transaction data sources 410, data storage system 110, log files 412, or external monitoring tools 414. Inputs 602 may include characteristics of data that are suitable to evaluation using a KRI. For example, inputs 602 may include a time series of raw variables, a time interval for aggregation, thresholds, or other suitable inputs 602.

In various embodiments, model efficiency enhancement methods 604 may be applied to inputs 602. Model input efficiency enhancement methods 604 may include applying transformations to the inputs such as, for example, logarithmic transformations, Bux Cox transformations, Fourier transformations, Laplace transformations, or other suitable transformations. Derived variables 606 may he derived from inputs 602 and/or model efficiency enhancement methods 604. Examples of derived variables 606 include a mean, median, 25^{th} percentile, 75^{th} percentile, missing values, N^{th} percentile, or other variables related to data integrity. An algorithm may operate on inputs 602 and/or derived variables 606 to generate outputs 610.

Example algorithms 608 suitable for application to inputs 602 and/or derived variables 606 include a time series decomposition (random, seasonality, trend. etc.), Grubb distance, median absolute deviation (MAD), Tukey's method (interquartile range), and hidden Markov models. Outputs 610 from algorithms 608 may include, for example, percentile values. Grubb output. MAD output, IRQ output. The outputs 610, inputs 602, outputs from model efficiency enhancement methods 604, and/or derived variables 606 may be analyzed using executable code (e.g., created using KRI builder 404) to determine whether to generate an alert for storage in alert repository 108.

Referring now to FIG. 6B, process flow 620 depicts the process of evaluating exceptions using KRIs, in accordance with various embodiments. Inputs 622 may be collected from a data source, such as transaction data sources 410, data storage system 110, log files 412, or external monitoring tools 414. Inputs 622 may include data suitable to preparation using algorithms 624 to generate outputs 628. Inputs may include, for example, raw variables or derived variables generated by transforming raw variables.

Example algorithms 624 suitable for application to inputs 622 to evaluate exceptions include a binary check, static evaluation (e.g., mean, median, standard deviation, etc.), linear regression, or logistic regression. Outputs 628 may include, for example, percentile values, Grubb outputs, MAD outputs, IRQ outputs, etc. The outputs may be analyzed using executable code (e.g., created using KRI builder 404) to determine whether to generate an alert for storage in alert repository 108. The executable code may be designed to take into consideration internal policies, regulations, internal controls, department guidelines, or other rules suitable to evaluation using executable code.

With reference to 6C, process flow 640 depicts the process of evaluating profiles and performance using KRIs and KPIs, in accordance with various embodiments. Inputs 642 may be collected from a data source, such as transaction data sources 410, data storage system 110, log files 412, or external monitoring tools 414. Inputs 642 may include characteristics of data that are suitable to evaluation using a KRI. For example, inputs 642 may include time series of raw variables or thresholds.

In various embodiments, model efficiency enhancement methods 644 may be applied to inputs 642. Model input efficiency enhancement methods 644 may include applying transformations to the inputs such as, for example, logarithmic transformations, Bux Cox transformations, Fourier transformations, Laplace transformations, or other suitable transformations. Derived variables 646 may be derived from inputs 642 and/or model efficiency enhancement methods 644. Examples of derived variables 646 relating to evaluation of profile and performance may include charge-off rate, a delinquency rate, or a fraud rate, or complaints by channel. An algorithm may operate on inputs 642 and./or derived variables 646 to generate outputs 650.

Examples of algorithms 648 suitable for application to inputs 642 and well suited to evaluating sudden shifts in the data stream include an autoregressive integrated moving average (ARIMA), exponent trends, smoothing, and stochastic models (e.g., Markov models). Examples of algorithms 648 well suited to evaluating persistent shifts include Cox Stuart, Mann Kendall trends, Pettit, Wald-Wolfowitz, and standard normal homogeneity. Outputs 650 from algorithms 648 may include, for example, p-values. The outputs 650, inputs 642, outputs from model efficiency enhancement methods 644, and/or derived variables 646 may be analyzed using executable code (e.g., created using KRI builder 404) to determine whether to generate an alert for storage in alert repository 108.

Referring now to FIG. 6D, process flow 660 depicts the process of evaluating external data using KRIs, in accordance with various embodiments. Inputs 662 may be collected from a data source, such as transaction data sources 410, data storage system 110, log files 412, external monitoring tools 414, websites, blogs, APIs, tweets and other social media updates. Inputs 662 may include characteristics of data that are suitable to evaluation using a KRI. For example, inputs 662 may include structured data (e.g., CSV), unstructured data (e.g., website content or tweets), or semi-structured data (e.g., JSON and XML).

Derived variables 664 may be derived from inputs 662. Examples of derived variables 664 relating to evaluation of external data may include data cleaned or standardized for modeling. An algorithm may operate on inputs 662 and/or derived variables 664 to generate outputs 670.

Examples of algorithms 666 suitable for application to inputs 662 and well suited to evaluating external data include term frequency-inverse document frequency (TF-IDF), naïve Baysean, random forest, logistic regression, hidden Markov models, support vector machines, kmeans clustering, principal component analysis (PCA), or recurrent neural networks (RNN). The outputs 670, inputs 662 and/or derived variables 664 may be analyzed using executable code (e.g., created using KRI builder 404) to determine whether to generate an alert for storage in alert repository 108. Outputs from algorithms 666 may be used in a feedback loop 668 for machine learning algorithms to improve derived variables 664 and/or outputs 670.

Referring now to FIG. 6E, process flow 680 depicts the process of generating insights using KRIs, in accordance with various embodiments. Inputs 682 may be collected from a data source, such as transaction data sources 410, data storage system 110, log files 412, or external monitoring tools 414. Inputs 682 may include characteristics of data that are suitable to evaluation using a KRI. For example, inputs 682 may include time series of raw variables and/or thresholds.

Derived variables 684 may be derived from inputs 682. Examples of derived variables 684 relating to generation of insights may include macro-economic indicators (e.g., leading, coincidental, lagging), delinquency rate, and fraud rate. An algorithm may operate on inputs 682 and/or derived variables 684 to generate outputs 690.

Examples of algorithms 686 suitable for application to inputs 682 and well suited to generating insights include co-relation matrices and factor analysis, for example. Outputs 690 from algorithms 686 may include insights. Examples of insights may include insights relating to market sentiments or co-relations as deduced from social media sources. The outputs 690, inputs 682 and/or derived variables 684 may be analyzed using executable code (e.g., created using Kit/builder 404) to determine whether to generate an alert or insight for storage in alert repository 108. Outputs from algorithms 686 may be used in a feedback loop 688 for machine learning algorithms to improve derived variables 684 and/or outputs 690.

Systems, methods and computer program products are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

The disclosure and claims do not describe only a particular outcome of generating alerts, but the disclosure and claims include specific rules for implementing the outcome of generating alerts and that render information into a specific format that is then used and applied to create the desired results of generating alerts, as set forth in McRO, Inc. v. Bandai Namco Games America Inc. (Fed. Cir, case number 15-1080, Sept. 13, 2016). In other words, the outcome of generating alerts can be performed by many different types of rules and combinations of rules, and this disclosure includes various embodiments with specific rules. While the absence of complete preemption may not guarantee that a claim is eligible, the disclosure does not sufficiently preempt the field of generating alerts at all. The disclosure acts to narrow, confine, and otherwise tie down the disclosure so as not to cover the general abstract idea of just generating alerts. Significantly, other systems and methods exist for generating alerts, so it would be inappropriate to assert that the claimed invention preempts the field or monopolizes the basic tools of generating alerts. In other words, the disclosure will not prevent others from generating alerts, because other systems are already performing the functionality in different ways than the claimed invention. Moreover, the claimed invention includes an inventive concept that may be found in the non-conventional and non-generic arrangement of known, conventional pieces, in conformance with Bascom v. AT&T Mobility, 2015-1763 (Fed. Cir. 2016). The disclosure and claims go way beyond any conventionality of any one of the systems in that the interaction and synergy of the systems leads to additional functionality that is not provided by any one of the systems operating independently. The disclosure and claims may also include the interaction between multiple different systems, so the disclosure cannot be considered an implementation of a generic computer, or just “apply it” to an abstract process. The disclosure and claims may also be directed to improvements to software with a specific implementation of a solution to a problem in the software arts.

In various embodiments, the system and method may include alerting a subscriber when their computer is offline. The system may include generating customized information and alerting a remote subscriber that the information can be accessed from their computer. The alerts are generated by filtering received information, building information alerts and formatting the alerts into data blocks based upon subscriber preference information. The data blocks are transmitted to the subscriber's wireless device which, when connected to the computer, causes the computer to auto-launch an application to display the information alert and provide access to more detailed information about the information alert. More particularly, the method may comprise providing a viewer application to a subscriber for installation on the remote subscriber computer; receiving information at a transmission server sent from a data source over the Internet, the transmission server comprising a microprocessor and a memory that stores the remote subscriber's preferences for information format, destination address, specified information, and transmission schedule, wherein the microprocessor filters the received information by comparing the received information to the specified information; generates an information alert from the filtered information that contains a name, a price and a universal resource locator (URL), which specifies the location of the data source; formats the information alert into data blocks according to said information format; and transmits the formatted information alert over a wireless communication channel to a wireless device associated with a subscriber based upon the destination address and transmission schedule, wherein the alert activates the application to cause the information alert to display on the remote subscriber computer and to enable connection via the URL to the data source over the Internet when the wireless device is locally connected to the remote subscriber computer and the remote subscriber computer comes online.

In various embodiments, the system and method may include a graphical user interface for dynamically relocating/rescaling obscured textual information of an underlying window to become automatically viewable to the user. By permitting textual information to be dynamically relocated based on an overlap condition, the computer's ability to display information is improved. More particularly, the method for dynamically relocating textual information within an underlying window displayed in a graphical user interface may comprise displaying a first window containing textual information in a first format within a graphical user interface on a computer screen; displaying a second window within the graphical user interface; constantly monitoring the boundaries of the first window and the second window to detect an overlap condition where the second window overlaps the first window such that the textual information in the first window is obscured from a user's view; determining the textual information would not be completely viewable if relocated to an unobstructed portion of the first window; calculating a first measure of the area of the first window and a second measure of the area of the unobstructed portion of the first window; calculating a scaling factor which is proportional to the difference between the first measure and the second measure; scaling the textual information based upon the scaling factor; automatically relocating the scaled textual information, by a processor, to the unobscured portion of the first window in a second format during an overlap condition so that the entire scaled textual information is viewable on the computer screen by the user; and automatically returning the relocated scaled textual information, by the processor, to the first format within the first window when the overlap condition no longer exists,

In various embodiments, the system may also include isolating and removing malicious code from electronic messages e.g., email) to prevent a computer from being compromised, for example by being infected with a computer virus. The system may scan electronic communications for malicious computer code and clean the electronic communication before it may initiate malicious acts. The system operates by physically isolating a received electronic communication in a “quarantine” sector of the computer memory. A quarantine sector is a memory sector created by the computer's operating system such that files stored in that sector are not permitted to act on files outside that sector. When a communication containing malicious code is stored in the quarantine sector, the data contained within the communication is compared to malicious code-indicative patterns stored within a signature database. The presence of a particular malicious code-indicative pattern indicates the nature of the malicious code. The signature database further includes code markers that represent the beginning and end points of the malicious code. The malicious code is then extracted from malicious code-containing communication. An extraction routine is run by a file parsing component of the processing unit. The file parsing routine performs the following operations: scan the communication for the identified beginning malicious code marker; flag each scanned byte between the beginning marker and the successive end malicious code marker; continue scanning until no further beginning malicious code marker is found; and create a new data file by sequentially copying all non-flagged data bytes into the new file, which forms a sanitized communication file. The new, sanitized communication is transferred to a non-quarantine sector of the computer memory. Subsequently, all data on the quarantine sector is erased. More particularly, the system includes a method for protecting a computer from an electronic communication containing malicious code by receiving an electronic communication containing malicious code in a computer with a memory having a boot sector, a quarantine sector and a non-quarantine sector; storing the communication in the quarantine sector of the memory of the computer, wherein the quarantine sector is isolated from the boot and the non-quarantine sector in the computer memory, where code in the quarantine sector is prevented from performing write actions on other memory sectors; extracting, via file parsing, the malicious code from the electronic communication to create a sanitized electronic communication, wherein the extracting comprises scanning the communication for an identified beginning malicious code marker, flagging each scanned byte between the beginning marker and a successive end malicious code marker, continuing scanning until no further beginning malicious code marker is found, and creating a new data file by sequentially copying all non-flagged data bytes into a new file that forms a sanitized communication file; transferring the sanitized electronic communication to the non-quarantine sector of the memory; and deleting all data remaining in the quarantine sector,

In various embodiments, the system may also address the problem of retaining control over customers during affiliate purchase transactions, using a system for co-marketing the “look and feel” of the host web page with the product-related content information of the advertising merchant's web page. The system can be operated by a third-party outsource provider, who acts as a broker between multiple hosts and merchants. Prior to implementation, a host places links to a merchant's webpage on the host's web page. The links are associated with product-related content on the merchant's web page. Additionally, the outsource provider system stores the “look and feel” information from each host's web pages in a computer data store, which is coupled to a computer server. The “look and feel” information includes visually perceptible elements such as logos, colors, page layout, navigation system, frames, mouse-over effects or other elements that are consistent through some or all of each host's respective web pages. A customer who clicks on an advertising link is not transported from the host web page to the merchant's web page, but instead is re-directed to a composite web page that combines product information associated with the selected item and visually perceptible elements of the host web page. The outsource provider's server responds by first identifying the host web page where the link has been selected and retrieving the corresponding stored “look and feel” information. The server constructs a composite web page using the retrieved “look and feel” information of the host web page, with the product-related content embedded within it, so that the composite web page is visually perceived by the customer as associated with the host web page. The server then transmits and presents this composite web page to the customer so that she effectively remains on the host web page to purchase the item without being redirected to the third party merchant affiliate. Because such composite pages are visually perceived by the customer as associated with the host web page, they give the customer the impression that she is viewing pages served by the host. Further, the customer is able to purchase the item without being redirected to the third party merchant affiliate, thus allowing the host to retain control over the customer. This system enables the host to receive the same advertising revenue streams as before but without the loss of visitor traffic and potential customers. More particularly, the system may be useful in an outsource provider serving web pages offering commercial opportunities. The computer store containing data, for each of a plurality of first web pages, defining a plurality of visually perceptible elements, which visually perceptible elements correspond to the plurality of first web pages; wherein each of the first web pages belongs to one of a plurality of web page owners; wherein each of the first web pages displays at least one active link associated with a commerce object associated with a buying opportunity of a selected one of a plurality of merchants; and wherein the selected merchant, the outsource provider, and the owner of the first web page displaying the associated link are each third parties with respect to one other; a computer server at the outsource provider, which computer server is coupled to the computer store and programmed to: receive from the web browser of a computer user a signal indicating activation of one of the links displayed by one of the first web pages; automatically identify as the source page the one of the first web pages on which the link has been activated; in response to identification of the source page, automatically retrieve the stored data corresponding to the source page; and using the data retrieved, automatically generate and transmit to the web browser a second web page that displays: information associated with the commerce object associated with the link that has been activated, and the plurality of visually perceptible elements visually corresponding to the source page.

As used herein, “satisfy”, “meet”, “match”, “associated with” or similar phrases may include an identical match, a partial match, meeting certain criteria, matching a subset of data, a correlation, satisfying certain criteria, a correspondence, an association, an algorithmic relationship and/or the like.

Terms and phrases similar to “associate” and/or “associating” may include tagging, flagging, correlating, using a look-up table or any other method or system for indicating or creating a relationship between elements, such as, for example, (i) a transaction account and (ii) an item (e.g., offer, reward, discount) and/or digital channel. Moreover, the associating may occur at any point, in response to any suitable action, event, or period of time. The associating may occur at pre-determined intervals, periodic, randomly, once, more than once, or in response to a suitable request or action. Any of the information may be distributed and/or accessed via a software enabled link, wherein the link may be sent via an email, text, post, social network input and/or any other method known in the art.

The phrases consumer, customer, user, account holder, account affiliate, cardmember or the like shall include any person, entity, business, government organization, business, software, hardware, machine associated with a transaction account, buys merchant offerings offered by one or more merchants using the account and/or who is legally designated for performing transactions on the account, regardless of whether a physical card is associated with the account. For example, the cardmember may include a transaction account owner, a transaction account user, an account affiliate, a child account user, a subsidiary account user, a beneficiary of an account, a custodian of an account, and/or any other person or entity affiliated or associated with a transaction account.

Phrases and terms similar to “transaction account” may include any account that may be used to facilitate a financial transaction.

Phrases and terms similar to “financial institution” or “transaction account issuer” may include any entity that offers transaction account services. Although often referred to as a “financial institution,” the financial institution may represent any type of bank, lender or other type of account issuing institution, such as credit card companies, card sponsoring companies, or third party issuers wider contract with financial institutions. It is further noted that other participants may be involved in some phases of the transaction, such as an intermediary settlement institution.

A record of charge (or ROC) may comprise any transaction or transaction data. The ROC may be a unique identifier associated with a transaction. Record of Charge (ROC) data includes important information and enhanced data. For example, a ROC may contain details such as location, merchant name or identifier, transaction amount, transaction date, account number, account security pin or code, account expiry date, and the like for the transaction. Such enhanced data increases the accuracy of matching the transaction data to the receipt data. Such enhanced ROC data is NOT equivalent to transaction entries from a banking statement or transaction account statement, which is very limited to basic data about a transaction. Furthermore, a ROC is provided by a different source, namely the ROC is provided by the merchant to the transaction processor. In that regard, the ROC is a unique identifier associated with a particular transaction. A ROC is often associated with a Summary of Charges (SOC). The ROCs and SOCs include information provided by the merchant to the transaction processor, and the ROCs and SOCs are used in the settlement process with the merchant. A transaction may, in various embodiments, be performed by a one or more members using a transaction account, such as a transaction account associated with a gift card, a debit card, a credit card, and the like.

Various processes of system 400 may run on distributed computing cluster, for example, a Hadoop® cluster configured to process and store big data sets with some of nodes comprising a distributed storage system and some of nodes comprising a distributed processing system. In that regard, distributed computing cluster may be configured to support a Hadoop® distributed file system (HDFS) as specified by the Apache Software Foundation at http://hadoop.apache.org/docs/. For more information on big data management systems, see U.S. Ser. No. 14/944,902 titled INTEGRATED BIG DATA INTERFACE FOR MULTIPLE. STORAGE. TYPES and filed on Nov. 18, 2015, U.S. Ser. No. 14/944,979 titled SYSTEM AND METHOD FOR READING AND WRITING TO BIG DATA STORAGE FORMATS and filed on Nov. 18, 2015; U.S. Ser. No. 14/945,032 titled SYSTEM AND METHOD FOR CREATING, TRACKING, AND MAINTAINING BIG DATA USE CASES and filed on Nov. 18, 2015; U.S. Ser. No. 14/944,849 titled SYSTEM AND METHOD FOR AUTOMATICALLY CAPTURING AND RECORDING LINEAGE DATA FOR BIG DATA RECORDS and filed on Nov. 18, 2015; U.S. Ser. No. 14/944,898 titled SYSTEMS AND METHODS FOR TRACKING SENSITIVE DATA IN A BIG DATA ENVIRONMENT and tiled on Nov. 18, 2015; and U.S. Ser. No. 14/944,961 titled SYSTEM AND METHOD TRANSFORMING SOURCE DATA INTO OUTPUT DATA IN BIG DATA ENVIRONMENTS and filed on Nov. 18, 2015, the contents of each of which are herein incorporated by reference in their entirety.

Any communication, transmission and/or channel discussed herein may include any system or method for delivering content (e.g. data, information, metadata, etc.), and/or the content itself. The content may be presented in any form or medium, and in various embodiments, the content may be delivered electronically and/or capable of being presented electronically. For example, a channel may comprise a website or device (e.g., Facebook, YOUTUBE®, APPLE®TV®, PANDORA®, XBOX®, SONY® PLAYSTATION®), a uniform resource locator (“URL”), a document (e.g., a MICROSOFT® Word® document, a MICROSOFT® Excel® document, an ADOBE® .pdf document, etc.), art “ebook,” an “emagazine,” an application or microapplication (as described herein), an SMS or other type of text message, an email, facebook, twitter, MMS and/or other type of communication technology. In various embodiments, a channel may be hosted or provided by a data partner. In various embodiments, the distribution channel may comprise at least one of a merchant website, a social media website, affiliate or partner websites, an external vendor, a mobile device communication, social media network and/or location based service. Distribution channels may include at least one of a merchant website, a social media site, affiliate or partner websites, an external vendor, and a mobile device communication. Examples of social media sites include FACEBOOK®, FOURSQUARE®, TWITTER®, MYSPACE®, LINKEDIN®, and the like. Examples of affiliate or partner websites include AMERICAN EXPRESS®, GROUPON®, LIVINGSOCIAL®, and the like. Moreover, examples of mobile device communications include texting, email, and mobile applications for smartphones.

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

For the sake of brevity, conventional data networking, application development and other functional aspects of the systems (and components of the individual operating components of the systems) may not be described in detail herein: Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., WINDOWS®, 0S2, UNIX®, LINUX®, SOLARIS®, MacOS, etc.) as well as various conventional support software and drivers typically associated with computers.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations. Useful machines for performing the various embodiments include general purpose digital computers or similar devices.

In fact, in various embodiments, the embodiments are directed toward one or more computer systems capable of carrying out the functionality described herein. The computer system includes one or more processors, such as processor. The processor is connected to a communication infrastructure (e.g., a communications bus, cross-over bar, or network). Various software embodiments are described in terms of this exemplary computer

system. After reading this description, it will become apparent to a person skilled in the relevant art(s) how to implement various embodiments using other computer systems and/or architectures. Computer system can include a display interface that forwards graphics, text, and other data from the communication infrastructure (or from a frame buffer not shown) for display on a display unit.

Computer systems also includes a main memory, such as for example random access memory (RAM), and may also include a secondary memory. The secondary memory may include, for example, a hard disk drive and/or a removable storage drive, representing a floppy disk drive, a magnetic tape drive, an optical disk drive, etc. The removable storage drive reads from and/or writes to a removable storage unit in a well-known manner. Removable storage unit represents a floppy disk, magnetic tape, optical disk, etc. which is read by and written to by removable storage drive. As will be appreciated, the removable storage unit includes a computer usable storage medium having stored therein computer software and/or data.

In various embodiments, secondary memory may include other similar devices for allowing computer programs or other instructions to be loaded into computer system. Such devices may include, for example, a removable storage unit and an interface. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from the removable storage unit to computer system.

Computer system may also include a communications interface. Communications interface allows software and data to be transferred between computer system and external devices. Examples of communications interface may include a modem, a network interface (such as an Ethernet card), a communications port, a Personal Computer Memory Card International Association (PCMCIA) slot and card, etc. Software and data transferred via communications interface are in the form of signals which may be electronic, electromagnetic, optical or other signals capable of being received by communications interface. These signals are provided to communications interface via a communications path (e.g., channel). This channel carries signals and may be implemented using wire, cable, fiber optics, a telephone line, a cellular link, a radio frequency (RF) link, wireless and other communications channels.

The terms “computer program medium” and “computer usable medium” and “computer readable medium” are used to generally refer to media such as removable storage drive and a hard disk installed in hard disk drive. These computer program products provide software to the computer system.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

In various embodiments, software may be stored in a computer program product and loaded into computer system using removable storage drive, hard disk drive or communications interface. The control logic (software), when executed by the processor, causes the processor to perform the functions of various embodiments as described herein.

In various embodiments, hardware components such as application specific integrated circuits (ASICs). Implementation of the hardware state machine so as to perform the functions described herein will be apparent to persons skilled in the relevant art(s). 100961 In various embodiments, the servers may include application servers (e.g. WEB SPHERE, WEB LOGIC, JBOSS, EDB® Postgres Plus Advanced Server® (PPAS),etc.). In various embodiments, the server may include web servers (e.g. APACHE, IIS, GWS, SUN JAVA® SYSTEM WEB SERVER). For example, a PMO or compliance team may interact with an application server to set local market rules and approve deletion schedules.

A web client includes any device (e.g., personal computer) which communicates via any network, for example such as those discussed herein. Such browser applications comprise Internet browsing software installed within a computing unit or a system to conduct online transactions and/or communications. These computing units or systems may take the form of a computer or set of computers, although other types of computing units or systems may be used, including laptops, notebooks, tablets, hand held computers, personal digital assistants, set-top boxes, workstations, computer-servers, main frame computers, mini-computers, PC servers, pervasive computers, network sets of computers, personal computers, such as IPADS®, IMACS®, and MACBOOKS®, kiosks, terminals, point of sale (POS) devices and/or terminals, televisions, or any other device capable of receiving data over a network. A web-client may run MICROSOFT® INTERNET EXPLORER®, MOZILLA® FIREFOX®, GOOGLE® CHROME®, APPLE® Safari, or am other of the myriad software packages available for browsing the internet.

Practitioners will appreciate that a web client may or may not be in direct contact with an application server. For example, a web client may access the services of an application server through another server and/or hardware component, which may have a direct or indirect connection to an Internet server. For example, a web client may communicate with an application server via a load balancer. In various embodiments, access is through a network or the Internet through a commercially-available web-browser software package.

As those skilled in the art will appreciate, a web client includes an operating system (e.g., WINDOWS®/CE/Mobile, OS2, UNIX®, LINUX®, SOLARIS®, MacOS, etc.) as well as various conventional support software and drivers typically associated with computers. A web client may include any suitable personal computer, network computer, workstation, personal digital assistant, cellular phone, smart phone, minicomputer, mainframe or the like. A web client can be in a home or business environment with access to a network. In various embodiments, access is through a network or the Internet through a commercially available web-browser software package. A web client may implement security protocols such as Secure Sockets Layer (SSL) and Transport Layer Security (TLS). A web client may implement several application layer protocols including http, https, ftp, and sftp.

As used herein, the term “network” includes any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., IPHONE®, BLACKBERRY®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, APPLE®talk, IP-6, NetBIOS®, OSI, any tunneling protocol (e.g. IPsec, SSII), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA® 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

The various system components may be independently, separately or collectively suitably coupled to the network via data links which includes, for example, a connection to an Internet Service Provider (ISP) over the local loop as is typically used in connection with standard modem communication, cable modem, Dish Networks®, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing at http://csrc.nist.gov/publications/nistpubs/800-145/SP800-145.pdf (last visited June 2012), which is hereby incorporated by reference in its entirety.

As used herein, “transmit” may include sending electronic data from one system component to another over a network connection. Additionally, as used herein, “data” may include encompassing information such as commands, queries, files, data for storage, and the like in digital or any other form.

Any databases discussed herein may include relational, hierarchical, graphical, blockchain, object-oriented structure and/or any other database configurations. Common database products that may be used to implement the databases include DB2 by IBM® (Armonk, N.Y.), various database products available from ORACLE® Corporation (Redwood Shores, Calif.), MICROSOFT® Access® or MICROSOFT® SQL Server® by MICROSOFT® Corporation (Redmond, Wash.), MySQL by MySQL AB (Uppsala, Sweden), MongoDB®, Redis®, Apache Cassandra®, or any other suitable database product. Moreover, the databases may be organized in any suitable manner, for example, as data tables or lookup tables. Each record may be a single file, a series of files, a linked series of data fields or any other data structure.

Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and tiles, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard ⁻format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual tiles using a hierarchical tiling system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

The computers discussed herein may provide a suitable website or other Internet-based graphical user interface which is accessible by users. In one embodiment, the MICROSOFT® INTERNET INFORMATION SERVICES® (IIS), MICROSOFT® Transaction Server (MTS), and MICROSOFT® SQL Server, are used in conjunction with the MICROSOFT® operating system, MICROSOFT® NT web server software, a MICROSOFT® SQL Server database system, and a MICROSOFT® Commerce Server. Additionally, components such as Access or MICROSOFT® SQL Server, ORACLE®, Sybase, Informix MySQL, Interbase, etc., may be used to provide an Active Data Object (ADO) compliant database management system. In one embodiment, the Apache web server is used in conjunction with a Linux operating system, a MySQL database, and the Perl, PHP, Ruby, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, JAVA® applets, JAVASCRIPT, active server pages (ASP), common gateway interface scripts (CGI), extensible markup language (XML), dynamic HTML, cascading style sheets (CSS), AJAX (Asynchronous JAVASCRIPT And XML), helper applications, plug-ins, and the like. A server may include a web service that receives a request from a web server, the request including a URL and an IP address (123.56.789.234). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. See, e.g., ALEX NGHEIM, IT WEB SERVICES: A ROADMAP FOR THE ENTERPRISE (2003), hereby incorporated by reference. For example, representational state transfer (REST), or RESTful, web services may provide one way of enabling interoperability between applications.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, JAVA®, JAVASCRIPT, JAVASCRIPT Object Notation (JSON), VBScript, Macromedia Cold Fusion, COBOL, MICROSOFT® Active Server Pages, assembly, PERL PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JAVASCRIPT, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “JAVA® Cryptography” by Jonathan Knudson, published by O′Reilly & Associates (1998); (3) “Cryptography & Network Security: Principles & Practice” by William Stallings, published by Prentice Hall; all of which are hereby incorporated by reference.

In various embodiments, the software elements of the system may also be implemented using Node.js®. Node.js® may implement several modules to handle various core functionalities. For example, a package management module, such as npm®, may be implemented as an open source library to aid in organizing the installation and management of third-party Node.js® programs. Node.js® may also implement a process manager, such as, for example, Parallel Multithreaded Machine (“PM2”); a resource and performance monitoring tool, such as, for example, Node Application Metrics (“appmetrics”); a library module for building user interfaces, such as for example ReachJS®; and/or any other suitable and/or desired module.

Each participant is equipped with a computing device in order to interact with the system and facilitate online commerce transactions. The customer has a computing unit in the form of a personal computer, although other types of computing units may be used including laptops, notebooks, hand held computers, set-top boxes, cellular telephones, touch-tone telephones and the like. The merchant has a computing unit implemented in the form of a computer-server, although other implementations are contemplated by the system. The bank has a computing center shown as a main frame computer. However, the bank computing center may be implemented in other forms, such as a mini-computer, a PC server, a network of computers located in the same of different geographic locations, or the like. Moreover, the system contemplates the use, sale or distribution of any goods, services or information over any network having similar functionality described herein,

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user WINDOWS®, webpages, websites, web forms, prompts, etc. Practitioners will appreciate that the illustrated steps described herein may comprise in any number of configurations including the use of WINDOWS®, webpages, web forms, popup WINDOWS®, prompts and the like. It should be further appreciated that the multiple steps as illustrated and described may be combined into single webpages and/or WINDOWS® but have been expanded for the sake of simplicity. In other cases, steps illustrated and described as single process steps may be separated into multiple webpages and/or WINDOWS® but have been combined for simplicity.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101,

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described various embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims.

Furthermore, no element, component, or method step in the present disclosure is intended to be dedicated to the public regardless of whether the element, component, or method step is explicitly recited in the claims. No claim element is intended to invoke 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus,

What is claimed is:

1. A method comprising:
receiving, by a monitoring station, a known risk indicator (KRI) comprising executable code for use in evaluating a variable from a data stream to identify a risk, wherein the data stream comprises at least one of a transactional data source, a big data storage system, a log file, or an external monitoring tool;
receiving, by the monitoring station and using a data ingestion hub, the variable from the data stream;
evaluating, by the monitoring station, the variable using the executable code of the KRI to detect the risk;
generating, by the monitoring station, an alert for storage in an alert repository in response to detecting the risk; and
assigning, by the monitoring station, the alert to a user account.

2. The method of claim 1, wherein the KRI is generated using a KRI builder to enter the executable code for use in evaluating the variable from the data stream.

3. The method of claim 1, further comprising updating, by the monitoring station, the KRI using a machine learning model applied to the alert from the alert repository.

4. The method of claim 1, further comprising hosting, by an application server in communication with the monitoring station, a case management tool comprising at least one of a KRI builder, an alert dashboard, a KRI dashboard, or a reporting engine.

5. The method of claim 4, wherein the alert dashboard generates real-time charts depicting change in the variable over time corresponding to the alert in the alert repository.

6. The method of claim 4, wherein the external monitoring tool monitors a social media source to detect at least one of a response to a marketing campaign or a response to an event in real-time.

7. The method of claim 4, wherein the reporting engine reads the alert from the alert repository to generate a report based on the alert.

8. The method of claim 1, wherein the evaluating the variable comprises applying at least one of a time series decomposition, a Grubb distance, a median absolute deviation, an interquartile range, or a hidden Markov model to the variable to identify the risk.

9. The method of claim 8, wherein the variable is a derived from the data stream and comprises at least one of a mean, a median, a predetermined percentile, a missing value.

10. The method of claim 1, wherein the evaluating the variable comprises applying at least one of a binary check, a static evaluation, a linear regression, or a logistic regression to the variable to identify the risk.

11. The method of claim 1, further comprising applying to an input variable at least one of a log transformation, a Bux-Cox transformation, or a Fourier transformation to derive the variable.

12. The method of claim 1, wherein the variable is derived from the data stream and comprises at least one of charge-off rate, a delinquency rate, or a fraud rate.

13. A method comprising:
receiving, by a monitoring station, a known performance indicator (KPI) comprising executable code for use in evaluating a variable from a data stream to detect a performance level, wherein the data stream comprises at least one of a transactional data source, a big data storage system, a log file, or an external monitoring tool;
receiving, by the monitoring station and using a data ingestion hub, the variable from the data stream;
evaluating, by the monitoring station, the variable using the executable code of the KPI to determine the performance level warrants an alert;
generating, by the monitoring station, the alert for storage in an alert repository in response to detecting the performance level warrants the alert; and
assigning, by the monitoring station, the alert to a user account.

14. The method of claim 13, wherein the variable is a derived from the data stream and comprises at least one of charge-off rate, a delinquency rate, or a fraud rate.

15. The method of claim 13, further comprising applying to an input variable at least one of a log transformation, a Bux-Cox transformation, or a. Fourier transformation to derive the variable.

16. The method of claim 13, wherein the evaluating the variable comprises detecting a sudden shift by applying an ARIMA, an exponential trend smoothing, or a stochastic model to the variable.

17. The method of claim 13, wherein the evaluating the variable comprises detecting a persistent shift by applying a Cox Stuart analysis, a Mann Kendall trend, a Pettitt analysis, a Wald-Wolfowitz analysis, or a standard normal homogeneity.

18. The method of claim 13, wherein the variable comprises a time series.

19. The method of claim 13, wherein the KPI is generated using a KPI builder to enter the executable code for use in evaluating the variable from the data stream.

20. The method of claim 13, further comprising updating, by the monitoring station, the KPI using a machine learning model applied to the alert from the alert repository.
